(19) United States
(12) Patent Application Publication
(10) Pub. No.: US 2015/0000405 A1
(43) Pub. Date: Jan. 1, 2015

(54) NON-DESTRUCTIVE EVALUATION METHODS FOR DETERMINING A THICKNESS OF A COATING LAYER ON A TURBINE ENGINE COMPONENT

(71) Applicant: HONEYWELL INTERNATIONAL INC., Morristown, NJ (US)

(72) Inventors: Surendra Singh, Gilbert, AZ (US); Jim Michael Ohm, Tempe, AZ (US); Frederick William Vensel, Gold Canyon, AZ (US); Richard Lee Krantz, Phoenix, AZ (US)

(21) Appl. No.: 13/928,538

(22) Filed: Jun. 27, 2013

(51) Int. Cl. G01B 17/02

(52) U.S. Cl. CPC G01B 17/025
USPC 73/627

(57) ABSTRACT

A method of non-destructively evaluating a thickness of a coating layer on a turbine engine component includes directing an acoustic wave into the turbine engine component, the acoustic wave including a frequency and a wavelength, receiving a return time-domain signal reflected from the turbine engine component, and transforming the time-domain signal into a frequency-domain signal. The method further includes subtracting a baseline signal from the frequency-domain signal and determining a local minimum frequency of the baseline-subtracted frequency-domain signal. Still further, the method includes calculating the thickness of the coating layer based on the determined local minimum frequency. Additional evaluation methods including ones based on resistivity, terahertz, and microwave are further disclosed.

### TECHNICAL FIELD

The inventive subject matter generally relates to turbine engine components, and more particularly relates to non-destructive evaluation methods for determining a thickness of a coating layer on a turbine engine component.

### BACKGROUND

Turbine engines are used as the primary power source for various kinds of aircraft. Turbine engines may also serve as auxiliary power sources that drive air compressors, hydraulic pumps, and industrial electrical power generators. Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge onto turbine blades mounted on a rotatable turbine disk. The force of the impinging gas causes the turbine disk to spin at high speed. Jet propulsion engines use the power created by the rotating turbine disk to draw more air into the engine, and the high velocity combustion gas is passed out of the gas turbine aft end to create forward thrust. Turbine engines may also be used to drive one or more propellers, electrical generators, or other devices.

Turbine engine blades and vanes are fabricated from high temperature materials such as nickel-based superalloys. Although nickel-based superalloys have good high temperature properties and many other advantages, they may be susceptible to corrosion, oxidation, thermal fatigue, and erosion damage in the harsh environment of an operating turbine engine. These limitations may be undesirable as there is a constant drive to increase engine operating temperatures in order to increase fuel efficiency and to reduce emissions. Replacing damaged turbine engine components made from nickel-based superalloys may be relatively expensive. Hence, significant research is being performed to find cost-effective ways to improve the temperature properties of these components as well as facilitate their repair. There has been an active pursuit in the art of different coatings to reduce metal temperatures and to reduce the incidence of thermo-mechanical fatigue (TMF) on the turbine engine components.

Various coatings are known in the art to reduce thermal damage on turbine engine components. The most prevalent coatings are: 1) thermal barrier coatings (TBC); 2) hydrophobic coatings; 3) high velocity oxygenated fuel coatings (HVOF); 4) thermal spray coatings, and 5) chemical vapor deposition coatings (CVD). With particular regard to thermal barrier coatings, TBCs are highly advanced material systems usually applied to metallic surfaces, such as gas turbine or aero-engine parts that operate at elevated temperatures, as a form of exhaust heat management. These coatings serve to insulate components from large and prolonged heat exposure by utilizing thermally insulating materials, as these coating are able to sustain an appreciable temperature difference between the load-bearing alloys and the coating surface. In doing so, these coatings allow components to operate at relatively high temperatures, while limiting the thermal exposure of structural components, and thereby, extending component life by reducing oxidation and thermal fatigue.

Regardless of the particular type of coating employed or the particular application method therefor, it has long been recognized that there is need for monitoring the thickness and the structural integrity in coating, to ensure that the coating functions as designed. The latter consideration includes thermal properties, elastic properties, density, porosity, and thermo-mechanical fatigue profiles. There are many monitoring methods available for this purpose including mechanical, optical, magnetic, X-Ray, electromagnetic, and radioactive techniques. However, current needs in the art, particularly with regard to high-precision turbine components, require dimension measurements with an accuracy that is generally not possible with the above-mentioned methods.

Accordingly, it would be desirable to provide methods capable of measuring turbine engine component coating thicknesses with improved precision. For example, it would be desirable to provide such methods capable of measuring thicknesses with a precision of +/−0.1 mils (0.0001 inch) or better. Other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Non-destructive evaluation methods for determining a thickness of a coating layer on a turbine engine component are provided.

In an embodiment, by way of example only, a method of non-destructively evaluating a thickness of a coating layer on a turbine engine component includes directing an acoustic wave into the turbine engine component, the acoustic wave including a frequency and a wavelength, receiving a return time-domain signal reflected from the turbine engine component, and transforming the time-domain signal into a frequency-domain signal. The method further includes subtracting a baseline signal from the frequency-domain signal and determining a local minimum frequency of the baseline-subtracted frequency-domain signal. Still further, the method includes calculating the thickness of the coating layer based on the determined local minimum frequency.

In another embodiment, by way of example only, a method of non-destructively evaluating a thickness of a coating layer on a turbine engine component includes placing first and second probes on an outer surface of the coating layer. The first and second probes are separated by a first distance. The first and second probes are configured to generate an electrical current in the coating layer. The method further includes placing third a fourth probes on the outer surface of the coating layer in a location that is between the first and second probes. The third and fourth probes are separated by a second distance that is less than the first distance. The third and fourth probes are configured to measure an electrical resistivity in the coating layer. Still further, the method includes generating an electrical current in the coating layer using the first and second probes, measuring the electrical resistivity of the coating layer using the third and fourth probes, and calculating the thickness of the coating layer based on the measured electrical resistivity.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The inventive subject matter will hereinafter be described in conjunction with the following drawing figures, wherein like numerals denote like elements, and:

FIG. 1 is an exemplary gas turbine engine component in accordance with one embodiment of the present disclosure;

FIG. 2 is a cross-sectional view of the component shown in FIG. 1, illustrating the coating system thereof;

FIG. 3 is an exemplary experimental setup in accordance with one embodiment of the present disclosure suitable for using ultrasonic wave methods to evaluate a thickness;

FIG. 4 illustrates the correlation between ring-down cycles and wavelength in the evaluation of a thickness using ultrasonic methods;

FIG. 5 illustrates the physical acoustic principles of ultrasonic wavelength NDE methods in accordance with an embodiment of the present disclosure;

FIGS. 6A through 6D illustrate exemplary time domain signals and frequency domain signals of a baseline sample and a coated sample;

FIG. 7 illustrates an exemplary experimental setup for use in the electrical resistivity testing NDE methods described herein;

FIGS. 8A through 8E illustrate an exemplary THz setup for calculating coating thickness by measuring THz waves in a coated sample in the time domain; and

FIG. 9 illustrates a correlation graph used comparing the measured pulse delay of the THz wave with a range of known coating thicknesses.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

Non-destructive evaluation (NDE) methods refer to a class of methods that can be used to inspect objects and analyze object for various material properties, without destroying or otherwise altering the objects in the process. NDE methods are often used to inspect materials for defects, such as structural anomalies, inclusions, cracks, etc. In the context of thermal barrier coatings, traditionally, coating thickness has been determined using a physical “cut-up” (cross-sectioned sample component). The physical cut-up is time-consuming, labor-intensive, and cost-prohibitive, in addition to requiring a long lead time and loss of samples. Therefore, some NDE methods have been proposed for determining coating thickness. Almost all NDE measurements, including thickness, are based on developed forward and inverse solutions. The forward solution (i.e., calibration curve) is developed by correlating NDE output with known thicknesses from physical cut-ups. The calibration curve should be developed using standards that have the same conductivity, permeability, substrate thickness, materials properties, and geometry as the parts being tested. Thus, the obtained forward solution is used for predicting and determining thickness, which is then referred to as the inverse solution.

NDE methods commonly used in the prior art for determining coating thicknesses include various forms of eddy current testing (ET). In a standard eddy current testing procedure, a circular coil carrying current is placed in proximity to the test component. The alternating current in the coil generates changing magnetic field which interacts with test component and generates an eddy current. Variations in the phase and magnitude of these eddy currents can be monitored using a second receiver coil, or by measuring changes to the current flowing in the primary excitation coil. Variations in the electrical conductivity or magnetic permeability of the test object, or the presence of any flaws, will cause a change in eddy current and a corresponding change in the phase and amplitude of the measured current. ET thickness determination in a coating depends largely on type of materials used for the coating and the substrate layers. ET methods have been shown to work well for various coating and substrate combinations, with one important exception: where the evaluated component has both a non-conducting coating and a non-conducting substrate. Examples of components with both non-conducting coatings and substrate include many TBC applications. Therefore, the conventional NDE methods used in the prior art are deficient in that they are not able to provide suitable thickness measurement for TBC applications.

Thus, embodiments of the present disclosure are directed to NDE methods for determining a thickness of a coating on a turbine engine component. The NDE methods of the present disclosure are divided into four basic classes: ultrasonic wave testing, electrical resistivity testing, terahertz wave testing, and microwave testing. Each such method involves the application of energy, either in the form of electromagnetic waves or electrical current, mechanical vibrations, to the component under evaluation, and a subsequent measurement of the energy after its interaction with the component.

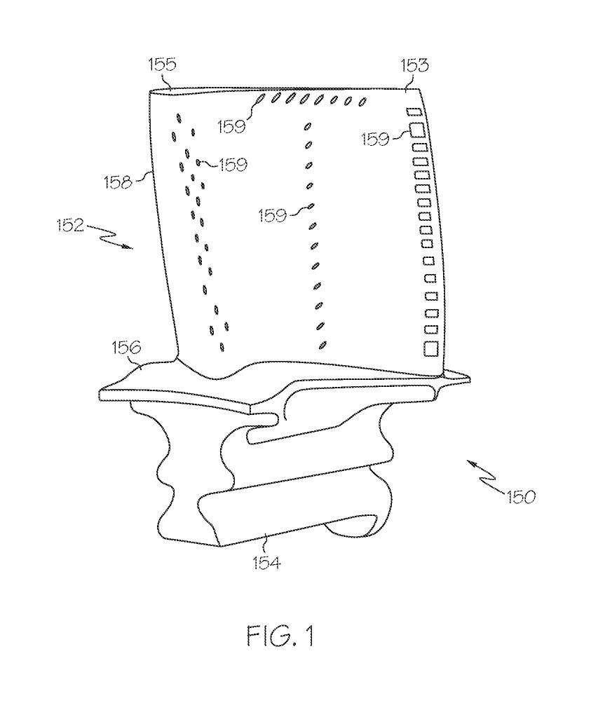

As noted above, the exemplary NDE methods described herein are particularly suited for evaluating a coating thickness on a turbine engine component. FIG. 1 is a perspective view of a turbine engine component 150, according to an embodiment. Here, the turbine engine component 150 is shown as a turbine blade. However, in other embodiments, the turbine engine component 150 may be a turbine vane or other component that may be implemented in a gas turbine engine, or other high-temperature system. In an embodiment, the turbine engine component 150 may include an airfoil 152 that includes a pressure side surface 153, an attachment portion 154, a leading edge 158 including a blade tip 155, and/or a platform 156. In accordance with an embodiment, the turbine engine component 150 may be formed with a non-illustrated outer shroud attached to the tip 155. The turbine engine component 150 may have non-illustrated internal air-cooling passages that remove heat from the turbine airfoil. After the internal air has absorbed heat from the blade, the air is discharged into a hot gas flow path through passages 159 in the airfoil wall. Although the turbine engine component 150 is illustrated as including certain parts and having a particular shape and dimension, different shapes, dimensions and sizes may be alternatively employed depending on particular gas turbine engine models and particular applications.

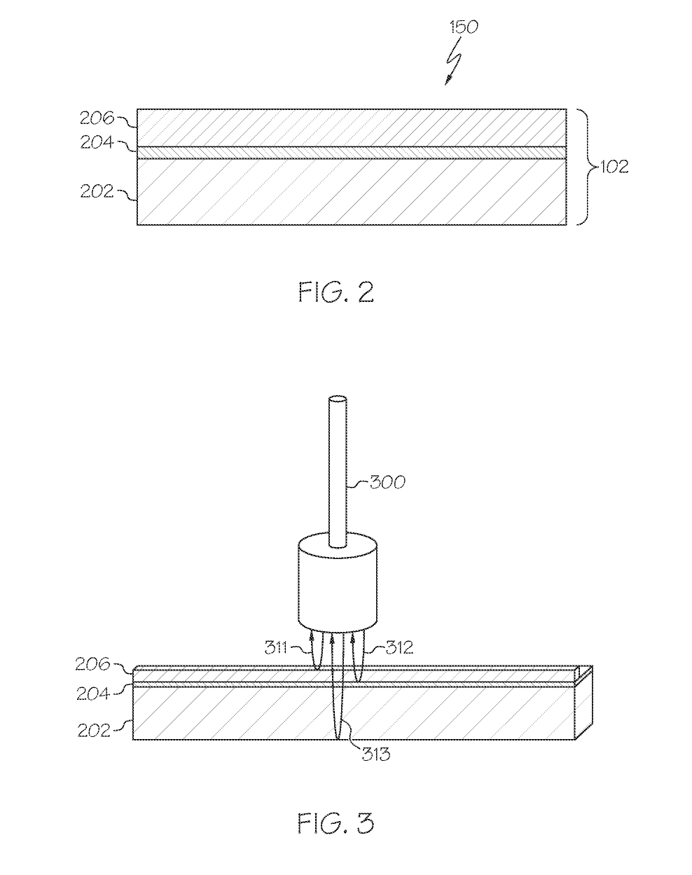

FIG. 2 shows a cross sectional view of a portion of the turbine engine component 150 that includes a coating system 102 formed thereon. In an embodiment, the coating system 102 includes a base material 202 which, as noted above, typically includes a nickel-based superalloy. For example, the first nickel-based superalloy may be selected from a high performance nickel-based superalloy, including, but not limited to IN792, C101, MarM247, Rene80, Rene125, ReneNS, SC180, CMSX 4, and PWA1484. The base material 202 may have a single crystal microstructure. In other embodiments, the base material 202 may include a directionally solidified or an equiaxed microstructure. The coating system 102 further includes an overlay coating 204 and a thermal barrier coating 206. The overlay coating 204 is preferably made of a material that protects the base material 202 from environmental conditions, such as high temperature gasses. Additionally, the overlay coating 204 acts as a bond coat onto which the thermal barrier coating 206 is deposited. Suitable materials of which the overlay coating 204 may include, but are not limited to MCrAlY and MCrAlYX, M being Ni, Co, Fe or combinations of Ni, Co and Fe, and X being additive elements such as Hf, Si, Zr, Re, Pt and others individually or in combination thereof The thermal barrier coating 206 may be formed over the overlay coating 204 and may include, for example, a ceramic. In one example, the thermal barrier coating 206 may include a partially stabilized zirconia-based thermal barrier coating, such as yttria stabilized zirconia (YSZ). In an embodiment, the thermal barrier coating may include yttria stabilized zirconia doped with other oxides, such as Gd₂O₃, TiO₂, and the like. The thermal barrier coating 206 may have a thickness that may vary and may be, for example, in a range from about 50 microns to about 300 microns. In other embodiments, the thickness of the thermal barrier coating 206 may be in a range of from about 100 microns to about 250 microns. In still other embodiments, the thermal barrier coating 206 may be thicker or thinner than the aforementioned ranges.

As noted above, embodiments of the present disclosure are directed primarily at NDE methods for determining the thickness of the thermal barrier coating 206. As the TBC 206 is typically provided on the order of a few tens to a few hundred microns, it is useful to have measurement capabilities therefore that are equally sensitive. The various forms of NDE methods of the present disclosure are described herein as follows.

### Ultrasonic Wave Testing

Conventional ultrasonic thickness evaluation operates by measuring the round-trip transit time of a high-frequency pulse as it travels through a material. Material thickness can often be measured to accuracies better than 0.01 inch (250 μm or 0.250 mm), with access to only one side of the material required. This approach works well in majority of NDE applications involving common engineering metals, plastics, and ceramics, as well as in rubber, fiberglass, composites, and even liquids and biological materials. However, in a growing number of cases, manufacturing quality control requires measurement of very thin material layers thicknesses, i.e., on the order of about 0.002 inch to about 0.010 inch, which are not susceptible for evaluation by conventional gauges. A newly developed approach to evaluating such thin materials, such as may be encountered in component coatings, is disclosed herein that involves frequency-domain signal analysis or the use of a very high test frequency.

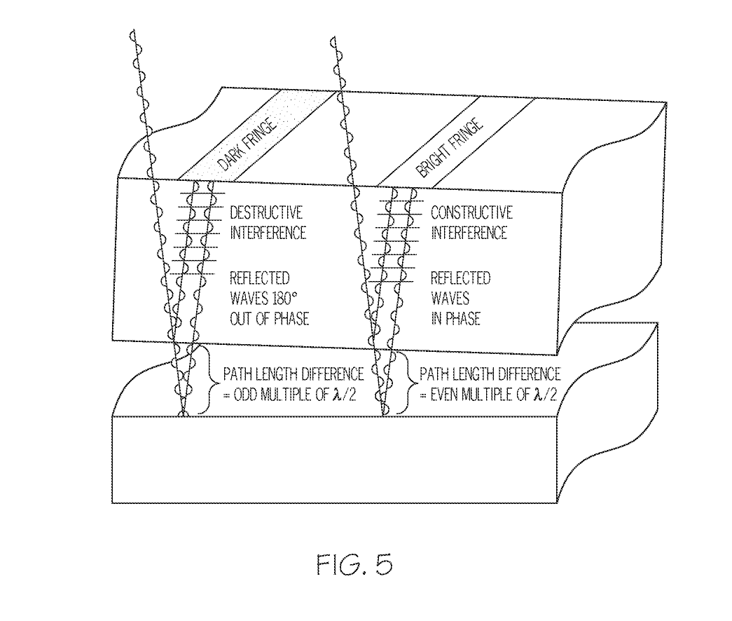

Generally, when dealing with thin layers such as turbine engine component coatings, thickness measurements are limited by the physics of sound waves. For measuring thin layer thickness, the ratio of thickness-to-wavelength (h/λ) should be high enough (equal to or greater than 2 to 3 times to wavelength) for separating the backwall echo from the initial pulse. Because of these realities, it is not practical to design an ultrasonic thickness gauge as it becomes challenge design high frequency transducer with low ring-down cycles (1 to 1.5 cycles). Therefore, conventional ultrasonic gauges even at high frequency 100 to 200 MHz are not suited for measuring thin layer thicknesses due in part to both inability to penetrate the coating and inadequate low ring-down cycles. For example, FIG. 4 shows ring-down cycles (401) that translate into the equivalent of three wavelengths (λ). The wavelength depends on frequency and materials under study. For example, 100 MHz transducer will generate long (three) ring-cycles spanning over more than about 180 μm (7.0 mils) in titanium. Thus, the 100 MHz transducer will not be able to resolve echoes reflected from layer thickness less than at least twice the 7.0 mils i.e., 14 mils. Therefore, there is a need for alternative approaches such as frequency domain signal analysis for replacing time-based methods.

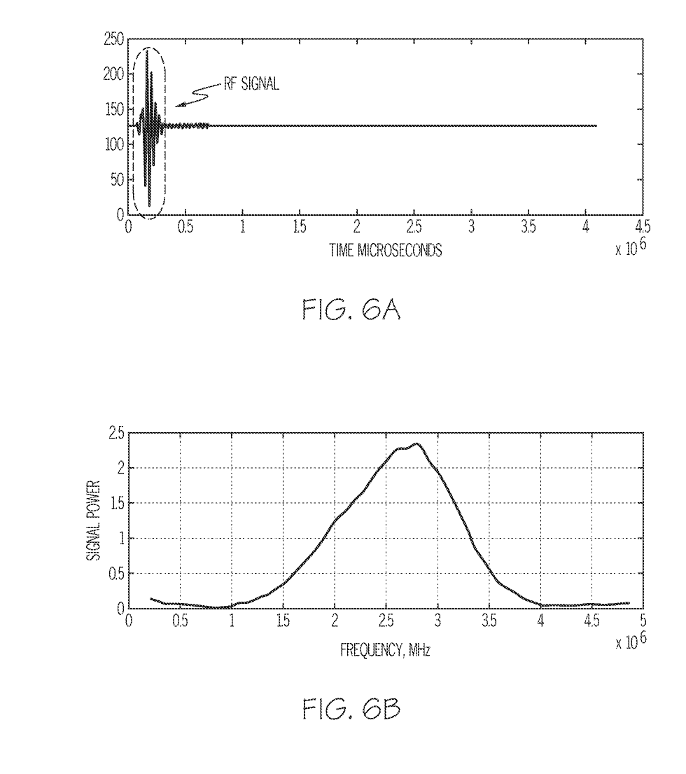

With reference to FIG. 5, the frequency-based methods work by observing the interference between the signals being reflected from the front end and back interfaces of the barrier layer. These two signals run into each other, and destructive wave interference occurs when the thickness of the layer is an integral multiple of half-wavelengths of sound. This phenomenon can be mathematically expressed as shown below.

$$Acoustic path difference ( Δ x ) = ( 2 n + 1 ) \frac{λ}{2}$$

where the acoustic path is the physical difference in waves reflected from back of substrate and wave reflected from layer back surface or layer-substrate interface; n is integer and n=0, 1, 2, 3, n; and λ is wavelength that is calculated from ratio of sound velocity in material to ultrasonic frequency as shown below.

$$Wavelegth ( inch ) = \frac{Sound velocity in materials ( \frac{inch}{microsecond} )}{Frequency , MHz}$$

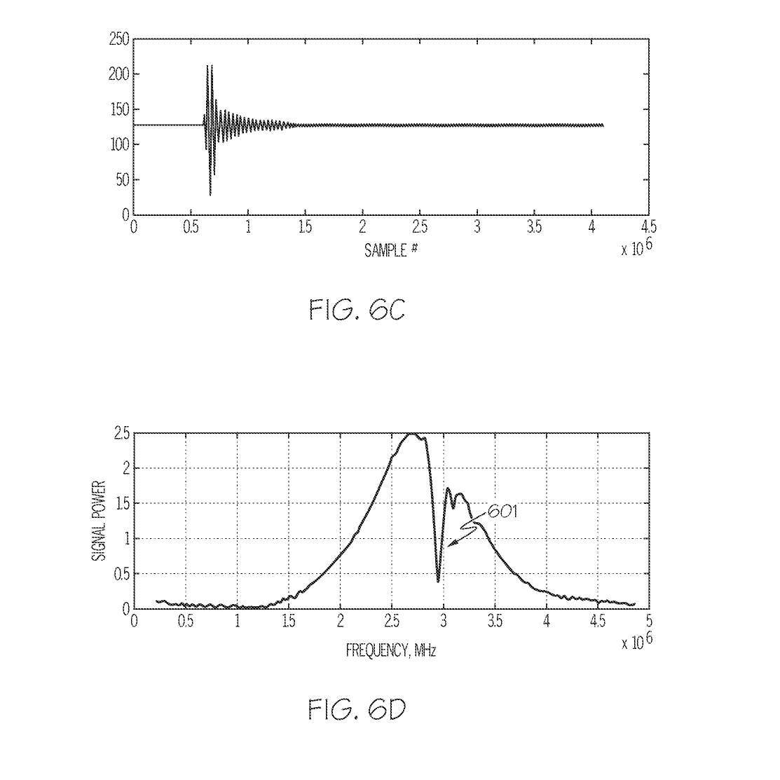

Thereafter, the method continues with digitizing the ultrasonic waveform from first surface of substrate with no thin coating layer and computing the baseline Fourier Transformation, as shown in FIG. 6A. Thereafter, the method includes a step of digitizing the ultrasonic waveform form the front surface of the thin coating layer and computing the Fourier Transformation, as shown in FIG. 6B. Thereafter, the baseline signal power spectrum is subtracted from the current spectrum. Then, the method includes a step of examining the corrected power spectrum and look for a minimum, indicated by arrow 601 in FIG. 6B. The location of the minimum is related to the thin layer thickness.

The presence of minimum in resultant frequency spectrum depends on the coating layer thickness. Normally, the locations of minimum in thin sample front echo fast Fourier Transform (FFT) depends on the sample thickness, as the back echo overlaps the front echo via ultrasonic interference and results into maximum and minimum. Using the resultant FFT for thin sample, one can determine the sample thickness by using the following equation:

$$Frequency = \frac{Velocity}{2 * Thickness}$$

The precision depends on the frequency measurements. Therefore, this method does not depend on the ratio of thickness and wavelength.

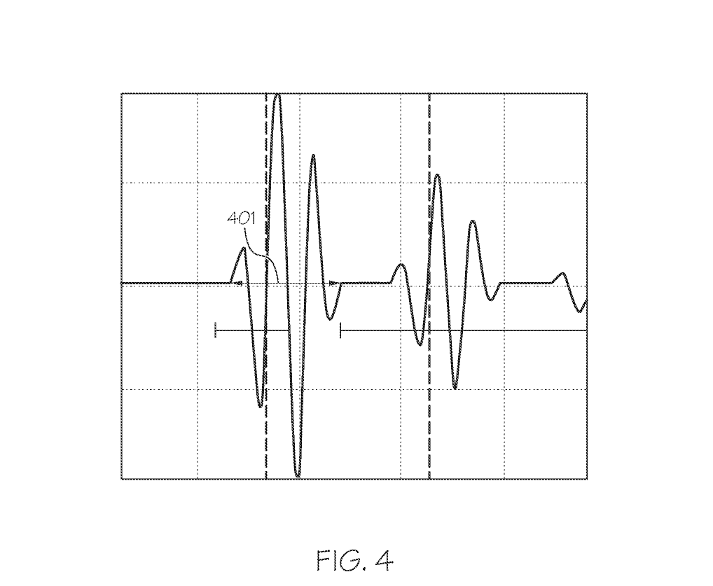

As indicated above, the proposed invention does not depend on the ratio of coating layer thickness to wavelength and thereby does not impose limit for using high-frequency transducer. One exemplary experimental setup is illustrated in FIG. 3. As shown therein, an ultrasonic transducer 300 is brought within the region of a test substrate 202 including a bond coat 204 and a top coat 206. The transducer 300 emits an ultrasonic signal which, once it passes into the coatings and substrate, results in an echo generated from the topcoat 206, from the bond coat 312, and from the substrate or back wall 313.

Performing the above-described evaluation methods, the obtained minimum frequency is used to calculate coating thickness using equation shown below.

$$Measured Minimum Frequency , MHz = \frac{Velocity , v}{2 * thickness ( t )}$$

### Electrical Resistivity Testing

In contrast to ultrasonic testing, resistivity is the intrinsic property of the material that depends on electrical resistance and is independent of shape and geometry of sample. Resistivity quantifies how strongly the material opposes the flow of electric current and is also known as specific resistance, volume resistivity, and bulk resistivity. A low resistivity indicates a material that readily allows the movement of electric charge. Irrespective of this difference in nomenclatures, resistivity is a material physical property similar to density, and is independent of shape and geometry and is expressed in units of ohm-cm.

Theoretically, resistivity is calculated by measuring resistance (R, ohm) by studying the ratio of applied voltage (Volt, V) to current (Ampere, I) in a sample as shown in Equation 4.

$$R ( Ohm ) = \frac{Volt ( V )}{Ampere ( I )}$$

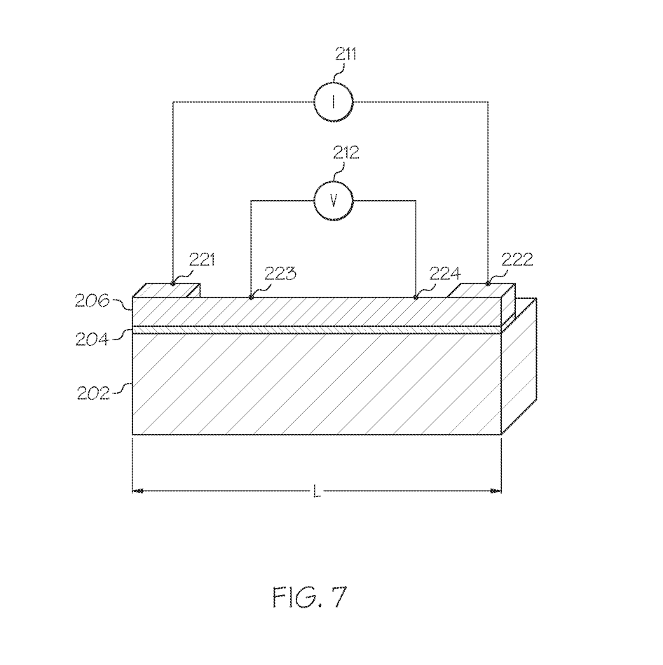

FIG. 7 shows an exemplary experimental setup for use in the electrical resistivity testing NDE methods described herein. Shown therein is a test component having a cross-sectional area (A) and a length (L). The component includes the substrate 202, the bond coat 204, and the top coat 206. During testing, an electrical current (211) is applied to the top coat 206 between two points on the surface thereof 221, 222. A voltage is then measured at two points 223, 224 that are within points 221, 222. Resistance to current flow is directly related to the length between two electrodes used for measuring current and inversely related to the cross-section perpendicular to the current. Therefore, R can be mathematically expressed as:

$$R ( Ohm ) ∝ \frac{L ( Length , cm )}{A ( Area , {cm}^{2}}$$

$$R ( Ohm ) = ρ ( ohm - cm ) \frac{L ( Length , cm )}{A ( Area , {cm}^{2}}$$

$$ρ = \frac{R \cdot A}{L}$$

For a successful four point measurements of resistivity (i.e., points 221-224), one needs to know something about the sample, i.e., a layer of the same conductivity as the substrate should not be be measured, as the substrate offers an easier path for the current, and the measured resistivity is effectively that of the substrate. The probes must be able to make ohmic contact with the materials, e.g., Germanium, Silicon, and metals. For example, high resistivity materials, e.g., ion implanted silicon wafers, silicon on sapphire, can be measured using a very low current (i.e., about 1 μA or less) and trying to avoid a greater voltage indication than 100 mV. On the other hand, low resistivity materials, e.g., aluminum, gold, platinum may require the maximum current from the current source to achieve a reading on the digital voltage display.

Also, the four points method described herein often uses correction factors based on the sample geometry, shape, and size being measured. The correction factor depends on the ratio of probe spacing to layer thickness as well as on the ratio of the latter to the substrate, and on the position of probes on the samples. For a layer thickness not exceeding 0.625 of the probe spacing the measurement is generally within 1% as an example. An exact quantitative estimate needs to be studied. If the layer thickness is equal to or greater than five times the probe spacing, the correction factor to be applied to the formula resistivity (rho)=2×π×spacing “s” ×V/I is less than 0.1%.

The “four point” probe measurement helps to separate the probe supplying current from the probe measuring the voltage; so it is only necessary to consider the “voltage probes”. The device used for measure the voltage is comes with very high input impedance. ASTM F 84 standard recommends at least 106 times the resistivity of the specimen. This helps keeping contact resistance small in comparison with the resistance in the voltage measuring circuit.

The measurement of bulk resistivity is similar to that of sheet resistivity except that a resistivity is reported using the layer thickness, t:

$$ρ = \frac{π}{ln ( 2 )} t ( \frac{V}{I} ) = 4.523 t ( \frac{V}{I} )$$

where t is the layer/wafer thickness in cm. The simple formula above works for when the layer thickness less than half the probe spacing (t<s/2).

### Tera Hertz Wave Testing

In many aspects, Terahertz (THz) waves behave similar to ultrasonic waves, i.e., both THz and UT follow Snell's law in refraction. Similar wave-propagation characteristics, such as velocity and attenuation, are quantities for both waves while studying materials. The following are the major differences between these two methods: 1) ultrasonic waves cannot traverse in vacuum whereas THz waves do; 2) ultrasonic waves are hampered by shadow effect but THz waves are not; and 3) ultrasonic waves can penetrate most solids but THz is limited by electrical conductivity.

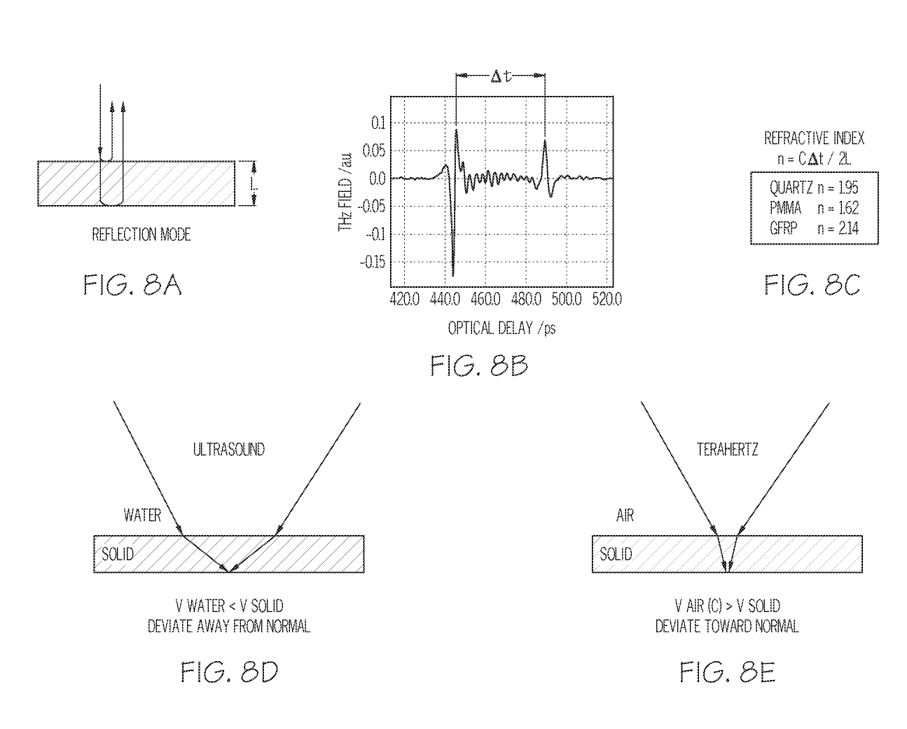

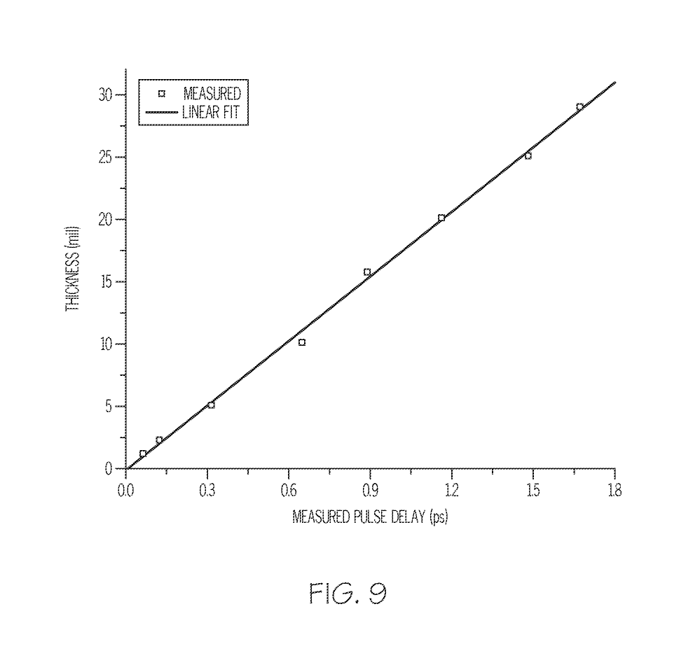

FIG. 8 shows typical THz setup for calculating coating thickness by measuring THz waves in a coated sample in the time domain. THz pulse echo measurements are made based on the refractive index of materials. Thereafter, the pulse echo measurements are correlated to known thicknesses, using a correlation graphs as shown by way of example in FIG. 9.

### Microwave Testing

Microwave testing is based on measuring the phase of the reflection coefficient at the interfaces in the coated samples. Measuring the phase of the reflection coefficient enables accurate calculation of the coating thickness.

Microwave NDE is simply based on wave reflection from a dielectric media interface. A uniform wave will be normally incident on the TBC interface. Then, according to the coating layer dielectric properties (permittivity and the loss factor), a part of this incident wave will be reflected from the interface, and another part will be transmitted and propagated through the thin layer. These forward and backward traveling waves inside the coating layer can be formulated.

Finally, the reflection coefficient is the ratio of the reflected and transmitted waves. Reflection coefficient is a function of various parameters such as the dielectric layer's thickness, standoff distance, dielectric properties, and operation frequency. Therefore, by measuring the reflection coefficient under certain conditions, it is possible to evaluate the above parameters.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of non-destructively evaluating a thickness of a coating layer on a turbine engine component, the method comprising:
directing an acoustic wave into the turbine engine component, the acoustic wave comprising a frequency and a wavelength;
receiving a return time-domain signal reflected from the turbine engine component;
transforming the time-domain signal into a frequency-domain signal;
subtracting a baseline signal from the frequency-domain signal;
determining a local minimum frequency of the baseline-subtracted frequency-domain signal; and
calculating the thickness of the coating layer based on the determined local minimum frequency.

2. The method of claim 1, wherein directing the acoustic wave comprises directing an ultrasonic acoustic wave.

3. The method of claim 2, wherein directing the ultrasonic wave is performed using an ultrasonic transducer.

4. The method of claim 2, wherein receiving the return time-domain signal is performed using an ultrasonic transducer.

5. The method of claim 1, wherein calculating the thickness of the coating layer comprises calculating the thickness of a coating layer having a thickness of 50 microns or less.

6. The method of claim 1, wherein calculating the thickness of the coating layer comprises calculating the thickness of a coating layer disposed over a bond coat, which in turn is disposed on the turbine engine component.

7. The method of claim 1, wherein the baseline signal is determined from an uncoated turbine engine component.

8. A method of non-destructively evaluating a thickness of a coating layer on a turbine engine component, the method comprising:
placing first and second probes on an outer surface of the coating layer, wherein the first and second probes are separated by a first distance, and wherein the first and second probes are configured to generate an electrical current in the coating layer;
placing third a fourth probes on the outer surface of the coating layer in a location that is between the first and second probes, wherein the third and fourth probes are separated by a second distance that is less than the first distance, and wherein the third and fourth probes are configured to measure an electrical resistivity in the coating layer;
generating an electrical current in the coating layer using the first and second probes;
measuring the electrical resistivity of the coating layer using the third and fourth probes; and
calculating the thickness of the coating layer based on the measured electrical resistivity.

9. The method of claim 8, wherein the first, second, third, and fourth probes are placed on the coating layer in a substantially linear fashion.

10. The method of claim 8, wherein the first, second, third, and fourth probes are configured to make ohmic contact with the coating layer.

11. The method of claim 8, wherein generating the electrical current comprises generating an electrical current that is about 1 μA or less for desired ohmic contact as an example.

12. The method of claim 11, measuring the electrical resistivity comprises ensuring that desired generated voltage is about 100 mV or less.

13. The method of claim 11, wherein the thickness of the coating layer is less than half of either the first or second distances.

14. The method of claim 8, wherein calculating the thickness of the coating layer comprises calculating the thickness of a coating layer disposed over a bond coat, which in turn is disposed on the turbine engine component.
